(19) United States
(12) Patent Application Publication
(10) Pub. No.: US 2006/0062235 A1
(43) Pub. Date: Mar. 23, 2006

(54) Apparatus and methods for modified Bluetooth® discovery and link establishment in presence of wireless local area network

(76) Inventor: Boris Ginzburg, Haifa (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/947,144

(22) Filed: Sep. 23, 2004

(51) Int. Cl. H04L 12/28

(52) U.S. Cl. 370/431

(57) ABSTRACT

In an apparatus having both a first communication module of a first communication type and a second communication module of a second communication type, initiating a reaction of the first module to an activity of the second module over a particular communication channel if the first module is about to perform an action at a particular carrier frequency for the purpose of entering a connected state with a device of the first communication type and the particular frequency overlaps the particular channel.

### BACKGROUND OF THE INVENTION

Certain standards for wireless communication that were developed by separate standardization bodies use overlapping frequency bands. For example, both the 802.11 specifications for Wireless LAN Medium Access Control (MAC) and Physical layer (PHY), developed by the Institute of Electrical and Electronics Engineers (IEEE), and the Bluetooth® core specifications v1.1, published Feb. 22, 2001 by the Bluetooth® special interest group (SIG), operate in the 2.4 gigahertz (GHz) frequency band.

Wireless communication compatible with one of these standards may interfere with collocated wireless communication compatible with another of these standards.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a simplified block diagram of an exemplary wireless communication system, in accordance with some embodiments of the invention;

FIG. 2 is a simplified flowchart of an exemplary modified Bluetooth® inquiry procedure to be executed by an inquiring device, according to some embodiments of the invention;

FIGS. 3 and 4 are simplified flowcharts of exemplary modified Bluetooth® inquiry procedures to be executed by a discoverable device, according to some embodiments of the invention; and

FIG. 5 is a simplified flowchart illustration of an exemplary modified Bluetooth® paging procedure to be executed by a paging device, according to some embodiments of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, components and circuits have not been described in detail so as not to obscure the embodiments of the invention.

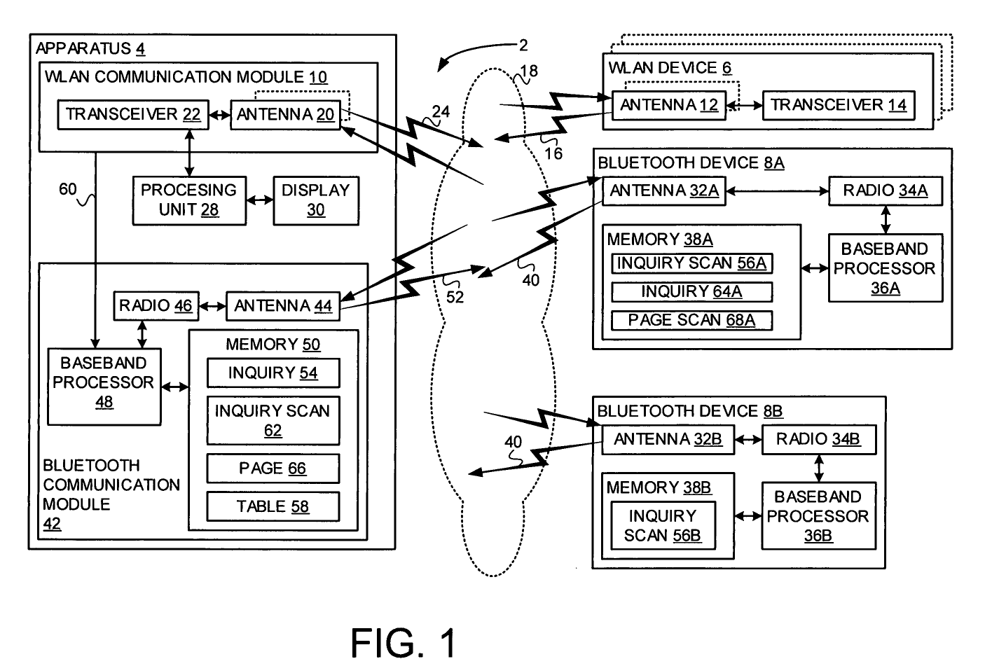

FIG. 1 is a simplified block diagram of an exemplary wireless communication system 2, in accordance with some embodiments of the invention. Wireless communication system 2 may include an apparatus 4, and may additionally include one or more wireless local area network (WLAN) devices 6 and one or more Bluetooth® (BT) devices 8. Wireless communication system 2 may include any number of BT devices 8, although for clarity only two BT devices, 8A and 8B are shown in detail in FIG. 1.

A non-exhaustive list of examples for apparatus 4 includes a WLAN station, a WLAN access point (AP), a work station, a server computer, a notebook computer, a laptop computer, a desktop personal computer, a personal digital assistant (PDA) computer, a hand-held computer, a WLAN-to-BT bridge, and the like.

A non-exhaustive list of examples for WLAN devices 6 includes WLAN stations, WLAN APs, work stations, server computers, notebook computers, laptop computers, desktop personal computers, PDA computers, hand-held computers, WLAN access points, WLAN mobile units, WLAN stationary units, WLAN add-on cards, WLAN personal computer memory card international association (PCMCIA) cards, WLAN personal computer (PC) cards, WLAN switches, WLAN routers, WLAN servers, game consoles, digital cameras, digital video cameras, television sets, and the like.

A non-exhaustive list of examples for BT devices 8 includes any of the following:

BT enabled human interface devices (HID) such as keyboards, mice, remote controllers, digital pens, and the like,

BT enabled audio devices such as headsets, loudspeakers, microphones, cordless telephones, handsets, stereo headsets and the like,

BT enabled computerized devices such as notebook computers, laptop computers, desktop personal computers, PDA computers, hand-held computers, cellular phones, moving picture experts group layer-3 audio (MP3) players, printers, facsimile machines, and the like, and

BT communication adapters such as universal serial bus (USB) adapters, PCMCIA cards, compact flash (CF) cards, mini peripheral component interconnect (PCI) cards, BT APs, and the like.

Apparatus 4 may include a WLAN communication module 10. WLAN devices 6 and WLAN communication module 10 may meet the following standards and/or other existing or future related standards, although this is a non-exhaustive list:
ANSI/IEEE standard 802.11 for Wireless LAN Medium Access Control (MAC) and Physical layer (PHY) specifications:
   Rev. b for Higher-speed physical layer extension in the 2.4 GHz band, published 1999,
   Rev. g for Further Higher data rate extension in the 2.4 GHz band, published 2003.

WLAN communication module 10 may be, for example, a WLAN add-on card, a WLAN PCMCIA card, a WLAN PC card, a mini PCI card, and the like.

WLAN devices 6 may each include at least one antenna 12, and a transceiver 14 coupled to antenna 12. WLAN devices 6 may be capable of transmitting WLAN signals 16 into a wireless medium 18, and of receiving signals from wireless medium 18. Similarly, apparatus 4 may include at least one antenna 20 and WLAN communication module 10 may include a transceiver 22 coupled to antenna 20. WLAN communication module 10 may be capable of transmitting a WLAN signal 24 into wireless medium 18, and of receiving signals from wireless medium 18. Antenna 20 may be located anywhere in apparatus 4.

WLAN devices 6 may be suitable to communicate with one another and with WLAN communication module 10 over wireless medium 18 in accordance with a particular WLAN standard, such as, for example, ANSI/IEEE standard 802.11 Rev. b or Rev. g (“802/11b/g”). Therefore, WLAN devices 6 and apparatus 4 can be referred to as “802.11-enabled devices”. Although the following description refers to definitions of 802.11b/g, it will be obvious to those skilled in the art how to modify the following for other WLAN standards.

802.11b/g defines fourteen alternative WLAN communication channels in the 2.4 GHz Federal Communication Commission (FCC) defined Industrial, Scientific and Medical (ISM) band to be used by WLAN devices to communicate with one other. Table 1 shows WLAN carrier frequencies F_{CWLAN} of the fourteen WLAN communication channels defined by 802.11b/g.

TABLE 1

| WLAN Communication | Carrier Frequency |
|---|---|
| Channel Number | F_{CWLAN}[GHz] |
| 1 | 2.412 |
| 2 | 2.417 |
| 3 | 2.422 |
| 4 | 2.427 |
| 5 | 2.432 |
| 6 | 2.437 |
| 7 | 2.442 |
| 8 | 2.447 |
| 9 | 2.452 |
| 10 | 2.457 |
| 11 | 2.462 |
| 12 | 2.467 |
| 13 | 2.472 |
| 14 | 2.484 |

A 802.11b/g WLAN is based on a cellular architecture where the system is subdivided into WLAN cells. One type of WLAN cell, known as a basic service set (BSS), contains WLAN stations controlled by a WLAN AP, and another type of WLAN cell, known as an independent basic service set (IBSS), contains WLAN stations which are not controlled by a WLAN AP.

In a BSS, WLAN stations may communicate with the WLAN AP over a common WLAN communication channel using a time sharing scheme. In an IBSS, WLAN stations may communicate directly with other WLAN stations over a common WLAN communication channel using a time sharing scheme. WLAN access points of different BSS-s may be connected via a distribution system (DS). The entire interconnected WLAN including the different WLAN cells, their respective WLAN access points and the distribution system may be known as an extended service set (ESS).

In the following description, a specific exemplary communication system 2 is described; however, the scope of the invention is not limited in this respect. In this specific example, one of WLAN devices 6 may act as a WLAN AP, connected in a BSS WLAN cell configuration over WLAN signals 16 and 24 to the other WLAN devices 6 and to WLAN communication module 10, acting as WLAN stations, using a common WLAN communication channel. Apparatus 4 may include a processing unit 28 coupled to transceiver 22, and a display 30 coupled to processing unit 28. Apparatus 4 may, for example, receive a moving picture experts group 4 (MPEG4) movie through WLAN communication module 10 and may, for example, concurrently display the MPEG4 movie on display 30.

BT devices 8 may each include an antenna 32, a radio 34, a baseband processor 36 and a memory 38. Radio 34 may be coupled to antenna 32 and to baseband processor 36, and baseband processor 36 may be coupled to memory 38. BT devices 8 may be capable of transmitting respective BT signals 40 into wireless medium 18, and of receiving signals from wireless medium 18.

Apparatus 4 may include a BT communication module 42 and an antenna 44. BT communication module 42 may include a radio 46 coupled to antenna 44, a baseband processor 48 coupled to radio 46, and a memory 50 coupled to processor 48. BT communication module 42 may be capable of transmitting a BT signal 52 into wireless medium 18, and of receiving signals from wireless medium 18. Antenna 44 may be located anywhere in apparatus 4.

BT devices 8 and BT communication module 42 may meet Bluetooth® core specifications v1.1, published by the Bluetooth® special interest group (SIG) and/or other existing or future related standards. In addition, any one of BT devices 8 may or may not meet Bluetooth® core specifications v1.2, published Nov. 5, 2003 by the Bluetooth® special interest group (SIG), which contains Adaptive Frequency Hopping (AFH) specification support, and BT communication module 42 may or may not meet Bluetooth® core specifications v1.2.

BT devices 8 and BT communication module 42 may be suitable to communicate with one another over BT signals 40 and 52 in accordance with those specifications. Therefore, BT devices 8 and apparatus 4 can be referred to as “Bluetooth®-enabled devices”. Although the following description refers to definitions of Bluetooth® core specifications v1.1 and v1.2, it will be obvious to those skilled in the art how to modify the following for other communication standards.

BT communication module 42 may be, for example, a BT add-on card, a BT PCMCIA card, a BT PC card, a CF card, a mini PCI card, and the like.

Bluetooth® core specifications v1.1 and v1.2 define seventy-nine BT carrier frequencies in the ISM band to be used by BT components to communicate with one other. The BT carrier frequencies (FCBT) are in the range of 2.402 GHz to 2.480 GHz and are spaced 1 megaHertz (MHz).

Communication between Bluetooth®-enabled devices may be conducted over a “physical channel”, which is the lowest architectural layer defined in Bluetooth® core specifications v1.1 and v1.2. One characteristic of a physical channel is periodic hopping between BT carrier frequencies.

In order for Bluetooth®-enabled devices, such as, for example, BT device 8A and BT communication module 42, to communicate over a physical channel, their radios, namely, radios 34A and 46, respectively, need to be tuned to the same BT carrier frequencies at the same time, and they need to be within a nominal range of each other, for example, 10 meters.

Bluetooth® core specifications v1.1 and v1.2 define four types of physical channels, denoted an “inquiry scan channel”, a “page scan channel”, a “basic piconet channel” and an “adapted piconet channel”.

An adapted piconet channel may be shared by AFH compatible Bluetooth®-enabled devices that are “connected” (that is, connection, denoted a “piconet”, between them has been established and communication packets can be sent back and forth). A connected BT device is known to be in a “connected state”.

One of the connected BT devices may serve as a “piconet master”, and the rest of the BT devices may serve as “piconet slaves”. Piconet slaves may communicate only with the piconet master, and may do so in response to being addressed by the piconet master.

An adapted piconet channel is characterized by a periodic pseudorandom hopping sequence through BT carrier frequencies at substantially equal time intervals (“BT time slots”) of 625 micro seconds (μS). The pseudorandom hopping sequence is determined by the piconet master, and the piconet slaves are required to remain synchronized to the pseudorandom hopping sequence. The piconet channel may hop between all seventy-nine BT carrier frequencies, or, alternatively, may hop between a subset of the seventy-nine BT carrier frequencies.

A basic piconet channel may be shared between connected BT devices if at least one of the connected BT devices is not AFH compatible. A basic piconet channel is substantially similar to an adaptive piconet channel, however, it hops between all seventy-nine BT carrier frequencies.

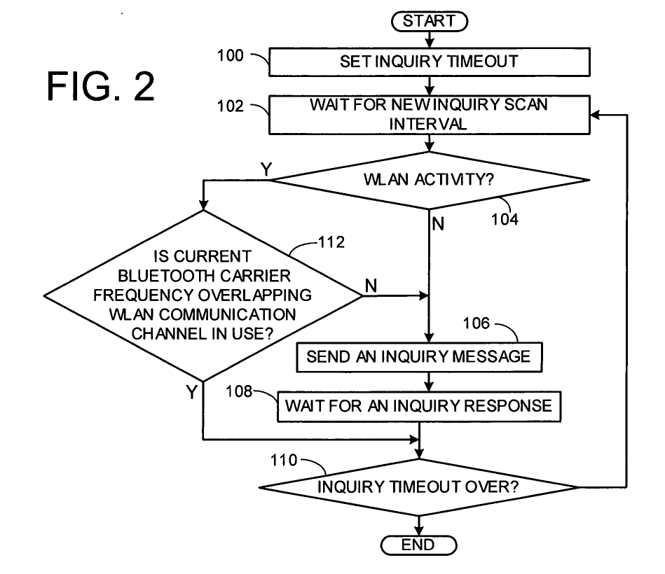

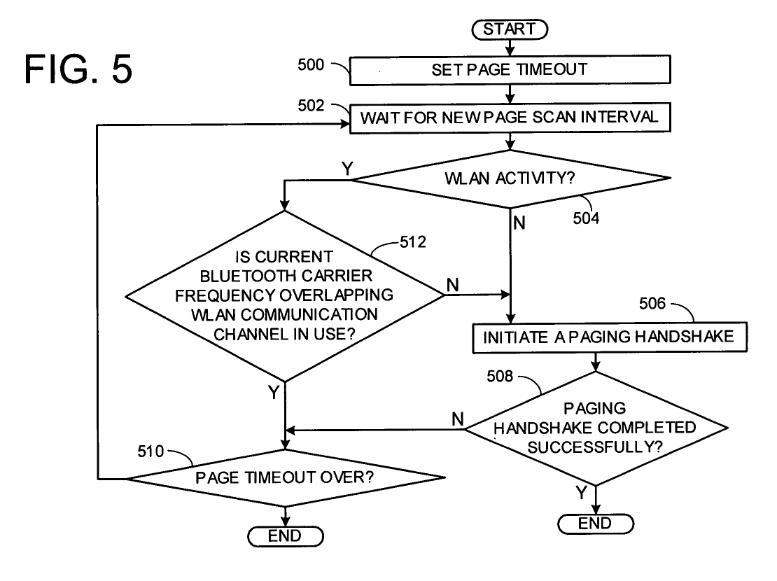

Bluetooth® devices may use an “inquiry (discovering)” procedure and a “paging (connecting)” procedure to enter a connected state and form a piconet. Bluetooth® core specifications v1.1 and v1.2 define inquiry and paging procedures. However, in the following description, modified parts of an inquiry procedure according to some embodiments of the invention are described in FIGS. 2, 3 and 4, and a modified part of a paging procedure according to some embodiments of the invention is described in FIG. 5.

### Inquiry Procedure

BT devices use the inquiry procedure to discover nearby BT devices, or to be discovered by BT devices in their locality. The inquiry procedure is asymmetrical. A BT device that tries to find other nearby devices may enter an “inquiry state”, and is known as an “inquiring device”. A BT device that tries to be discovered by nearby devices may enter an “inquiry scan state”, and is known as a “discoverable device”. One reason for a BT device to enter an inquiry state or an inquiry scan state is as a response to a command from a human operator to do so.

The inquiry scan channel is characterized by a periodic predefined pseudorandom inquiry hopping sequence through thirty-two predefined BT carrier frequencies. The inquiry hopping sequence is identical for both inquiring devices and discoverable devices, and is determined by a special Bluetooth® device address (BD) denoted a General Inquiry Access Code (GIAC). Moreover, the thirty-two predefined BT carrier frequencies of the inquiry hopping sequence are substantially evenly distributed among the 79 BT carrier frequencies.

An inquiring device may hop between BT carrier frequencies in “inquiry intervals” of approximately 312.5 μS and 937.5 μS, and once in an inquiry interval, the inquiring device may transmit an inquiry message over the respective BT carrier frequency. An inquiry message may contain either the GIAC or a “Limited Inquiry Access Code” (LIAC) and may be sent using the native BT clock of the inquiring device.

Transmission time of an inquiry message may be approximately 68 μS. An inquiring device may complete an inquiry hopping sequence through all thirty-two BT carrier frequencies in approximately 20 mS.

A discoverable device may hop from one BT carrier frequency to another once per “inquiry scan interval”. The duration of an inquiry scan interval may be programmable. Once per inquiry scan interval, the discoverable device may open its radio for an “inquiry scan window” for receiving signals over the respective BT carrier frequency. The duration of an inquiry scan window may be adjusted so that the discoverable device is able to receive inquiry messages from an inquiring device over at least a minimal number of BT carrier frequencies. This minimal number of BT carrier frequencies may be, for example, sixteen.

It may be appreciated that while a discoverable device completes one inquiry scan interval of a 1.28 S duration, for example, an inquiring device may complete hopping approximately 64 times through all thirty-two predefined BT carrier frequencies. Moreover, while a discoverable device completes one inquiry scan window of, for example, a 11.25 mS duration, an inquiring device may complete hopping between approximately 18 BT carrier frequencies.

During an inquiry scan window, a discoverable device may receive an inquiry message over the BT carrier frequency to which the discoverable device is tuned. If the inquiry message contains a LIAC to which the discoverable device ought to respond, or if the inquiry message contains a GIAC, the discoverable device may wait a random “back-off” period of up to 640 μS and may enter an “inquiry response state”.

If while in the inquiry response state the discoverable device receives again a similar inquiry message, the discoverable device may respond by transmitting an “inquiry response”. An inquiry response may be, for example, a frequency hopping synchronization (FHS) packet, containing at least the BT device address and the native BT clock of the discoverable device.

The inquiring device may receive the inquiry response, and may store the information contained in the inquiry response. A discoverable device for which its inquiry response is received and stored by the inquiring device is referred to as a “connectable device”. The inquiring device may optionally use the paging procedure to connect to connectable devices.

A BT communication performed by BT communication module 42 over a BT carrier frequency F_{CBT} may potentially interfere with WLAN communication performed by WLAN communication module 10 over a WLAN communication channel F_{CWLAN} if the BT carrier frequency F_{CBT} and the carrier frequency F_{CWLAN} of the WLAN communication channel“overlap”.

In the following description, a BT carrier frequency F_{CBT} is considered to be overlapping a WLAN communication channel F_{CWLAN} if F_{CBT} is within ±10 MHz of F_{CWLAN}. Consequently, a WLAN communication channel may have 21 respective overlapping BT carrier frequencies, which are approximately 27% of the total seventy-nine BT carrier frequencies, and which cover approximately 27% of the thirty-two BT carrier frequencies of the inquiry hopping sequence. It may be appreciated that any other definition of overlap between a BT carrier frequency and a WLAN communication channel is within the scope of the invention.

An inquiry message may be transmitted at a frequency of approximately 50 times per second over each particular BT carrier frequency in the sequence. Since for any WLAN communication channel approximately 27% of the BT carrier frequencies are overlapping, the result may be interference to the WLAN communication during execution of the inquiry procedure.

For example, in exemplary wireless communication system 2, inquiry messages that may be sent, for example, between BT communication module 42 and BT device 8A, according to the native inquiry procedure defined in Bluetooth® core specifications v1.1 and v1.2, may interfere with reception of the MPEG4 movie by apparatus 4. Such interference may result, for example, in a visible degradation of the picture quality of the MPEG4 movie displayed on display 30.

WLAN communication module 10 may generate a WLAN channel-busy indication 60 to indicate the WLAN communication channel in use, and baseband processor 48 may receive WLAN channel-busy indication 60. WLAN channel-busy indication 60 may be a hard-wired indication. Alternatively, WLAN channel-busy indication 60 may be a software indication, such as, for example, a write operation performed by WLAN communication module 10 to a register (not shown) in baseband processor 48.

WLAN channel-busy indication 60 may indicate whether WLAN communication module 10 is tuned to a WLAN communication channel, and may indicate the number of that channel. Moreover, WLAN channel-busy indication 60 may indicate the type of activity, if any, being performed by WLAN communication module 10 over that WLAN communication channel. Such an activity may be, for example, reception or transmission of 802.11 signals. Furthermore, WLAN channel-busy indication 60 may indicate whether the activity has priority over activities of BT communication module 42.

According to some embodiments of the invention, BT communication module 42 may be an inquiring device and may be in an inquiry state. In addition, BT devices 8A and 8B may be discoverable devices and may both be in an inquiry scan state. Memory 50 may store an inquiry module 54, memory 38A may store an inquiry scan module 56A, and memory 38B may store an inquiry scan module 56B.

In exemplary communication system 2, BT communication module 42 may receive FHS packets from BT devices 8A and 8B, and may store the received FHS packets in, for example, a table 58 in memory 50.

Reference is made now to FIG. 2, which is a simplified flowchart of an exemplary modified part of a Bluetooth® inquiry procedure to be executed by baseband processor 48 in an inquiry state, according to some embodiments of the invention.

At the beginning of the method, BT communication module 10 enters an inquiry state and may set an inquiry timeout of, for example, 10.24 S, or any other period that is less than 30.72 S (100). BT communication module 10 may enter a new inquiry scan interval (102). Inquiry module 54 may monitor WLAN channel-busy indication 60 for WLAN activity (104), and if WLAN channel-busy indication 60 indicates that WLAN communication module 10 is not communicating, inquiry module 54 may control baseband processor 48 to transmit an inquiry message (106) and to wait for an inquiry response (108).

If the inquiry timeout is over (110), the method may terminate. Otherwise, the method may continue to box (102).

If WLAN channel-busy indication 60 indicates that WLAN communication module 10 communicates over a specific WLAN communication channel, inquiry module 54 may check whether the particular BT carrier frequency overlaps the specific WLAN communication channel (112). If the particular BT carrier frequency overlaps the specific WLAN communication channel, the method may continue to box (110) without transmitting an inquiry message. However, if the particular BT carrier frequency does not overlap the specific WLAN communication channel, the method may continue to box (106).

According to some other embodiments of the invention, BT communication module 42 may be a discoverable device and may be in an inquiry scan state. In addition, BT device 8A may be an inquiring device and may be in an inquiry state. Memory 50 may store an inquiry scan module 62 and memory 38A may store an inquiry module 64A.

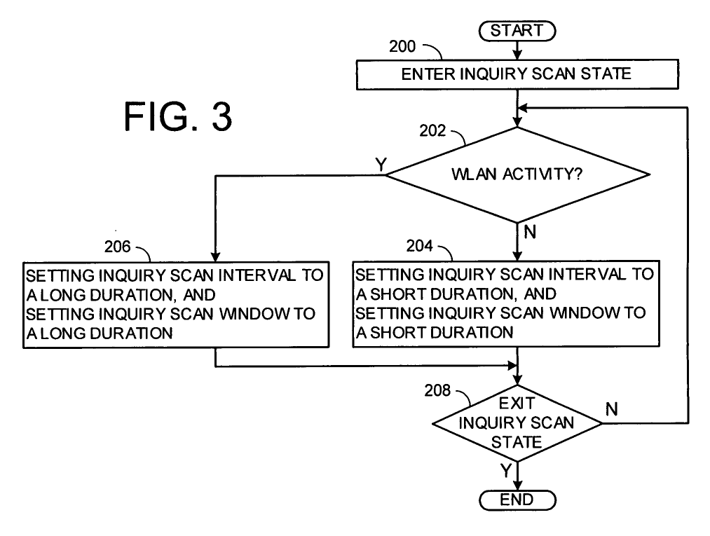

Reference is made now to FIG. 3, which is a simplified flowchart of an exemplary modified part of a Bluetooth® inquiry scan procedure to be executed by baseband processor 48 in an inquiry scan state, according to some embodiments of the invention.

At the beginning of the method, BT communication module 42 may enter an inquiry scan state (200). Inquiry scan module 62 may monitor WLAN channel-busy indication 60 for WLAN activity (202), and may set the inquiry scan window and inquiry scan interval of BT communication module 10 accordingly.

For example, inquiry scan module 62 may set the inquiry scan window so that BT communication module 10 is able to receive inquiry messages from an inquiring device over at least sixteen BT carrier frequencies.

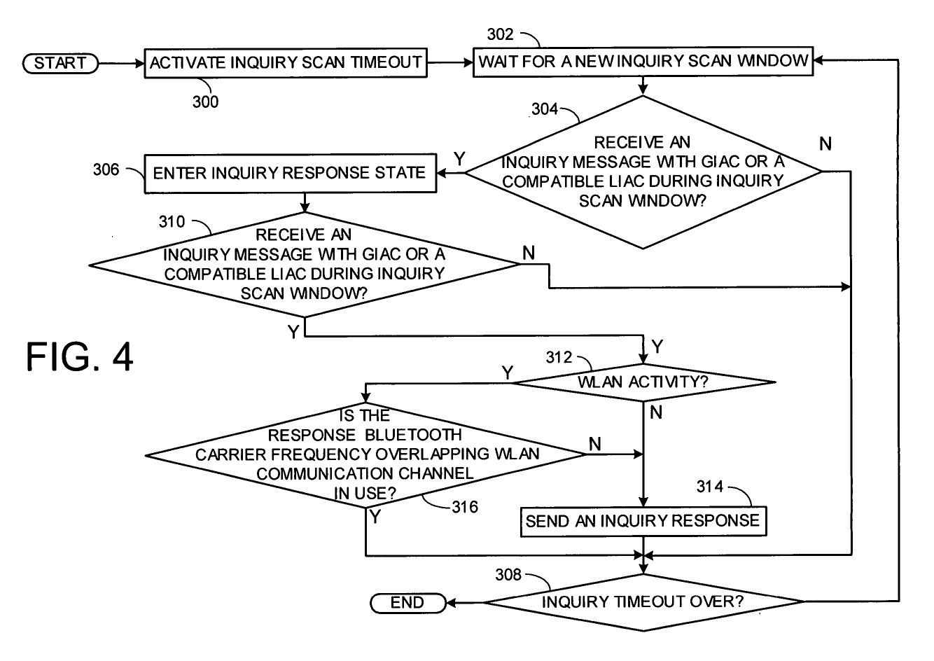

If WLAN channel-busy indication 60 indicates that WLAN communication module 10 is not communicating, inquiry scan module 62 may set the inquiry scan window to, for example, 11.25 mS, and may set the inquiry scan interval to, for example, 2.56 S (204). However, if WLAN channel-busy indication 60 indicates that WLAN communication module 10 is communicating, a longer inquiry scan window and a longer inquiry scan interval may be needed if, for example, baseband processor 48 uses a method similar to the exemplary method described hereinbelow in FIG. 4. Inquiry scan module 62 may set the inquiry scan window to a value up to, for example, 54 mS, and may set the inquiry scan interval to, for example, 1.60 S (206).

If BT communication module 10 exits the inquiry scan state (208), the method may terminate, otherwise, the method may continue to box (202).

Reference is made now to FIG. 4, which is a simplified flowchart of another exemplary modified part of a Bluetooth® inquiry scan procedure to be executed by baseband processor 48 in an inquiry scan state, according to some embodiments of the invention.

At the beginning of the method, BT communication module 42 enters an inquiry scan state and may set an inquiry scan timeout of, for example, 10.24 S or any other period that is less than 30.72 S (300). BT communication module 42 may enter an inquiry scan window (302). During the inquiry scan window, BT communication module 42 may receive an inquiry message originated from, for example, BT device 8A. If such an inquiry message is received, inquiry scan module 62 may check whether the received inquiry message contains a LIAC to which BT communication module 42 ought to respond, or a GIAC (304).

If the received inquiry message contains a LIAC to which BT communication module 42 ought to respond, or contains a GIAC, BT communication module 42 may enter an inquiry response state (306). Otherwise, inquiry scan module 62 may check whether the inquiry scan timeout is over (308). If the inquiry scan timeout is over, the method may terminate. Otherwise, the method may continue to box (302).

While BT communication module 42 is in inquiry response state, it may receive an inquiry message, similar to the one received in box (306). If such an inquiry message is not received while BT communication module 42 is in inquiry response state (310), the method may continue to box (308). Otherwise, inquiry scan module 62 may monitor WLAN channel-busy indication 60 for WLAN activity (312). If WLAN channel-busy indication 60 indicates that WLAN communication module 10 is not communicating, inquiry scan module 62 may control baseband processor 48 to transmit an inquiry response (314), and the method may continue to box (308).

If WLAN channel-busy indication 60 indicates that WLAN communication module 10 communicates over a specific WLAN communication channel, inquiry scan module 62 may check whether a particular BT carrier frequency, on which BT communication module 42 ought to transmit an inquiry response, overlaps the specific WLAN communication channel (316). If the particular BT carrier frequency overlaps the specific WLAN communication channel, the method may continue to box (308) without transmitting an inquiry response. However, if the particular BT carrier frequency does not overlap the specific WLAN communication channel, the method may continue to box (312).

### Paging Procedure

The paging procedure is asymmetrical. The BT device that is referred to as the inquiring device during the inquiry phase may enter a “page state” and may try to connect to connectable devices as a piconet master. During the paging phase, this device is referred to as a “paging device”. Connectable devices may enter a “page scan state” and may try to connect to the paging device as piconet slaves.

A paging device may establish a page scan channel with a particular connectable device in order to connect with the particular connectable device. A page scan channel is characterized by a periodic predefined pseudorandom page hopping sequence through the same thirty-two BT carrier frequencies used for the inquiry scan channel. The page hopping sequence is identical for both the paging device and the particular connectable device, and the hopping sequence-is determined by the BD of the particular connectable device.

A paging device may hop between BT carrier frequencies in interlacing “page intervals” of approximately 312.5 μS and 937.5 μS. Once per page interval, the paging device may try to initiate a paging handshake with the particular connectable device by transmitting a page message that contains at least the BD of the particular connectable device over the respective BT carrier frequency.

The transmission time of a page message may be approximately 681 μS. A paging device may complete a page hopping sequence through all thirty-two BT carrier frequencies in approximately 20 mS.

A connectable device may hop from one BT carrier frequency to another once per “page scan interval”. The duration of a page scan interval may be programmable. Once per page scan interval, the connectable device may open its radio for a “page scan window” for receiving signals over the respective BT carrier frequency. The duration of a page scan window may be adjusted so that the connectable device is able to receive page messages from a paging device over at least a minimal number of BT carrier frequencies. This minimal number of BT carrier frequencies may be, for example, sixteen.

It may be appreciated that while a connectable device completes one page scan interval of a 1.28 S duration, for example, a paging device may complete hopping approximately 64 times through all thirty-two predefined BT carrier frequencies. Moreover, while a connectable device completes one page scan window of, for example, a 11.25 mS duration, a paging device may complete hopping between approximately 18 BT carrier frequencies.

During a page scan window, a connectable device may receive a page message over a BT carrier frequency f(K) to which the connectable device is tuned. After a predetermined amount of time after transmitting the page message, the paging device may tune its radio to a BT carrier frequency f′(K) to potentially receive signals from the connectable device. BT carrier frequency f′(K) is predefined by BT carrier frequency f(K) and by the BD of the connectable device.

If the page message contains the BD of the connectable device, the connectable device may continue the paging handshake by transmitting a first “slave page response” to the paging device over BT carrier frequency f′(K). The paging device may receive the first page response, and may continue the paging handshake by transmitting a “master page response” over a BT carrier frequency f(K+1). BT carrier frequency f(K+1) is predetermined by BT carrier frequency f(K) and by the BD of the connectable device. The master page response may contain a FHS packet with at least the BT device address and the native BT clock of the paging device.

The connectable device may receive the FHS packet over BT carrier frequency f(K+1) and may continue the paging handshake by transmitting a second slave page response. The paging device may successfully complete the paging handshake by sending a POLL packet to the connectable device.

A paging message may be transmitted at a frequency of approximately 50 times per second over each particular BT carrier frequency in the sequence. Since for any WLAN communication channel approximately 27% of the BT carrier frequencies are overlapping, the result may be interference to the WLAN communication during execution of the inquiry procedure.

According to some embodiments of the invention, BT communication module 42 may be a paging device and may be in a page state. In addition, BT devices 8A may be a connectable device and may be in a page scan state. Memory 50 may store a page module 66 and memory 38A may store a page scan module 68A.

Reference is made now to FIG. 5, which is a simplified flowchart of an exemplary modified part of a Bluetooth® paging procedure to be executed by baseband processor 48 in a page state, according to some embodiments of the invention.

At the beginning of the method, BT communication module 42 enters a page state and may set a page timeout of, for example, 10.24 S (500). BT communication module 42 may enter a new page scan interval (502). Page module 66 may monitor WLAN channel-busy indication 60 for WLAN activity (504), and if WLAN channel-busy indication 60 indicates that WLAN communication module 10 is not communicating, page module 66 may initiate a paging handshake with a connectable device by controlling baseband processor 48 to transmit a page message over a BT carrier frequency f(K) (506). If the paging handshake is completed successfully (508) the method may terminate. However, if the paging handshake is not completed successfully, page module 66 may check whether the page timeout is over (510). If the page timeout is over, the method may terminate. Otherwise, the method may continue to box (502).

If at box (504) WLAN channel-busy indication 60 indicates that WLAN communication module 10 communicates over a specific WLAN communication channel, page module 66 may check whether BT carrier frequency f(K) overlaps the specific WLAN communication channel (512). If BT carrier frequency f(K) overlaps the specific WLAN communication channel, the method may continue to box (510) without transmitting a paging message. However, if BT carrier frequency f(K) does not overlap the specific WLAN communication channel, the method may continue to box (506).

A non-exhaustive list of examples for antennae 12, 20, 32 and 44 includes dipole antennae, monopole antennae, multilayer ceramic antennae, Planar inverted-F antennae, loop antennae, shot antennae, dual antennae, omni-directional antennae and any other suitable antennas.

A non-exhaustive list of examples for baseband processors 36 and 48 includes a central processing unit (CPU), a digital signal processor (DSP), a reduced instruction set computer (RISC), a complex instruction set computer (CISC) and the like. Moreover, processor 36 and/or processor 48 may be part of an application specific integrated circuit (ASIC) or may be a part of an application specific standard product (ASSP).

A non-exhaustive list of examples for memories 38 and 50 includes any combination of the followings: registers, latches, read only memory (ROM), mask ROM, electrically erasable programmable read only memory devices (EEPROM), flash memory devices, non-volatile random access memory devices (NVRAM), synchronous dynamic random access memory (SDRAM) devices, RAMBUS dynamic random access memory (RDRAM) devices, double data rate (DDR) memory devices, static random access memory (SRAM), and the like.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the spirit of the invention.

What is claimed is:

1. A method comprising:
initiating a reaction of a first communication device of a first communication type to an activity of a communication device of a second communication type over a particular communication channel if said first communication device is about to perform an action at a particular carrier frequency for the purpose of entering a connected state with a second communication device of said first communication type and said particular frequency overlaps said particular channel.

2. The method of claim 1, wherein said first communication type is Bluetooth® core specifications v1.1 or v1.2.

3. The method of claim 1, wherein said action includes transmission of an inquiry message and said reaction includes canceling said transmission.

4. The method of claim 1, wherein said action includes transmission of an inquiry response and said reaction includes canceling said transmission.

5. The method of claim 1, wherein said action includes initiating a paging handshake with said second communication device of said first communication type and wherein said reaction includes canceling initiation of said paging handshake.

6. The method of claim 1, wherein said action includes setting an inquiry scan interval to a first duration and said reaction includes setting said inquiry scan interval to a second duration that is longer than said first duration.

7. The method of claim 1, wherein said action includes setting an inquiry scan window to a first duration and said reaction includes setting said inquiry scan window to a second duration that is longer than said first duration.

8. The method of claim 1, wherein said second communication type is 802.11g.

9. The method of claim 8, further comprising:
identifying that the type of said activity is reception of a 802.11g signal.

10. The method of claim 8, further comprising:
identifying that the type of said activity is reception of a high priority 802.11g signal.

11. The method of claim 8, further comprising:
identifying that the type of said activity is transmission of a 802.11g signal.

12. The method of claim 8, further comprising:
identifying that the type of said activity is transmission of a high priority 802.11g signal.

13. The method of claim 1, further comprising:
monitoring a hard-wired indication generated by said communication device of said second communication type; and
identifying said particular channel and identifying the type of said activity from said indication.

14. The method of claim 1, further comprising:
monitoring a software indication generated by said communication device of said second communication type; and
identifying said particular channel and identifying the type of said activity from said indication.

15. An article comprising a storage medium having stored thereon instructions that, when executed, result in:
initiating a reaction of a first Bluetooth core specifications v1.2 device to an activity of a 802.11g device over a particular 802.11g communication channel if said first Bluetooth device is about to perform an action at a particular Bluetooth carrier frequency for the purpose of entering a connected state with a second Bluetooth core specifications v1.2 device and said particular frequency overlaps said particular channel.

16. The article of claim 15, wherein said action includes transmission of an inquiry message and said reaction includes canceling said transmission.

17. The article of claim 15, wherein said action includes transmission of an inquiry response and said reaction includes canceling said transmission.

18. The article of claim 15, wherein said action includes initiating a paging handshake with said second Bluetooth device and wherein said reaction includes canceling initiation of said paging handshake.

19. The article of claim 15, wherein said action includes setting an inquiry scan interval to a first duration and said reaction includes setting said inquiry scan interval to a second duration that is longer than said first duration.

20. The article of claim 15, wherein said action includes setting an inquiry scan window to a first duration and said reaction includes setting said inquiry scan window to a second duration that is longer than said first duration.

21. An apparatus comprising:
a first communication module of a first communication type to perform an activity over a particular communication channel; and
a second communication module of a second communication type including a monopole antenna, a radio coupled to said antenna, and a processor,
wherein if said second communication module is about to perform an action at a particular carrier frequency for the purpose of entering a connected state with a device of said second communication type and said particular frequency overlaps said particular channel, said processor is to initiate a reaction of said second communication module to said activity.

22. The apparatus of claim 21, wherein said second communication type is Bluetooth® core specifications v1.1 or v1.2.

23. The apparatus of claim 21, wherein said first communication type is 802.11g.

24. The apparatus of claim 21, wherein said action includes transmission of an inquiry message and said reaction includes canceling said transmission.

25. The apparatus of claim 21, wherein said action includes transmission of an inquiry response and said reaction includes canceling said transmission.

26. The apparatus of claim 21, wherein said action includes initiating a paging handshake with said device and wherein said reaction includes canceling initiation of said paging handshake.

27. The apparatus of claim 21, wherein said action includes setting an inquiry scan interval to a first duration and said reaction includes setting said inquiry scan interval to a second duration that is longer than said first duration.

28. The apparatus of claim 21, wherein said action includes setting an inquiry scan window to a first duration and said reaction includes setting said inquiry scan window to a second duration that is longer than said first duration.

29. The apparatus of claim 21, wherein said action includes setting an inquiry scan interval to a first duration and said reaction includes:
setting said inquiry scan interval to a second duration that is longer than said first duration.

30. The apparatus of claim 21, wherein said action includes setting an inquiry scan window to a first duration and said reaction includes:
setting said inquiry scan window to a second duration that is longer than said first duration.

31. The apparatus of claim 21, wherein said first communication module is to generate a hard-wired indication and said processor is to monitor said hard-wired indication and to identify therefrom said particular channel and the type of said activity.

32. The apparatus of claim 21, wherein said first communication module is to generate a software indication and said processor is to monitor said software indication and to identify therefrom said particular channel and the type of said activity.
